(19) United States
(12) Patent Application Publication
(10) Pub. No.: US 2020/0008478 A1
(43) Pub. Date: Jan. 9, 2020

(54) ELECTRONIC CIGARETTE

(71) Applicant: SHENZHEN IVPS TECHNOLOGY CO., LTD., Shenzhen (CN)

(72) Inventor: Junwei OUYANG, Shenzhen (CN)

(73) Assignee: SHENZHEN IVPS TECHNOLOGY CO., LTD., Shenzhen (CN)

(21) Appl. No.: 16/503,527

(22) Filed: Jul. 4, 2019

(30) Foreign Application Priority Data
Jul. 5, 2018 (CN) 201821058177. 7

(51) Int. Cl. A24F 47/00; H05B 3/06

(52) U.S. Cl. CPC A24F 47/008; H05B 2203/016; H05B 3/06

(57) ABSTRACT

The present invention discloses an electronic cigarette, which comprises a main body, a heating device and a locking device movably mounted to the main body, wherein the main body is provided with a mounting chamber having an opening, the heating device is detachably mounted in the mounting chamber, the heating device is provided with a locking portion, when the locking device moves to engage with the locking portion, the heating device is locked in the first position in the mounting chamber to electrically connect the heating device to the main body, the locking device moves to be disengaged from the locking portion, and the heating device moves from the first position to the second position, so that the heating device partially protrudes from the opening of the mounting chamber. The technical solution of the present invention effectively facilitates detaching and cleaning the internal heating device.

### TECHNICAL FIELD

The present invention relates to an electronic cigarette.

### BACKGROUND

Studies have shown the use of “heating non-burning”. Related studies have shown that nicotine and some tobacco flavor components can be transferred to smoke in a manner of only heating but not burning tobacco at a lower temperature below 500° C. Compared to traditional burning cigarettes, low temperature cigarettes can significantly reduce the release of tar and harmful components as a whole. At the same time, there is basically no sidestream smoke, which is of little harm to others and the environment.

The existing low-temperature flue-cured tobacco is usually provided with a heating chamber for the user to add tobacco products, and then the tobacco products in the heating chamber are heated by providing a heating device. However, the substance produced by the tobacco products during heating tends to adhere to the heating chamber and the surface of the heating device, and the heating chamber cannot be detached from the electronic cigarette. When cleaning, the cleaning device needs to extend into the heating chamber to clean the chamber wall of the heating chamber and the surface of the heating device, resulting in the deficiency that it is more difficult to clean and the degree of cleaning is lower.

### SUMMARY

The main object of the present invention is to provide an electronic cigarette, which is intended to facilitate detaching and cleaning the internal heating device.

In order to achieve the above object, the present invention provides an electronic cigarette, comprising a main body, a heating device, and a locking device movably mounted to the main body, wherein the main body is provided with a mounting chamber having an opening, the heating device is detachably mounted in the mounting chamber, the heating device is provided with a locking portion, when the locking device moves to engage with the locking portion, the heating device is locked in the first position in the mounting chamber to electrically connect the heating device with the main body, the locking device moves to be disengaged from the locking portion, and the heating device moves from the first position to the second position, so that the heating device partially protrudes from the opening of the mounting chamber.

Preferably, the locking device comprises a locking head and a controlling member, one end of the controlling member is movably mounted to the main body and exposed to the outside of the main body, and the other end extends into the main body to be connected with the locking head; the controlling member moves to the locking head to engage with the locking portion, the heating device is locked in the first position, the controlling member moves to disengage the locking head from the locking portion, and the heating device moves from the first position to the second position.

Preferably, the locking device further comprises an elastic body, and the elastic body is mounted between the main body and the controlling member so that the controlling member rebounds.

Preferably, the locking head comprises a limiting portion and a connecting portion connected to the limiting portion, the heating device is provided with a locking groove to form the locking portion, one end of the connecting portion away from the limiting portion is mounted to the controlling member, and when the controlling member moves to splice the limiting portion into the locking groove, the heating device is locked in the first position.

Preferably, the locking device further comprises an ejecting mechanism, the ejecting mechanism is mounted to the main body, when the heating device is locked in the first position, the ejecting mechanism is extruded, and when the locking device is disengaged from the locking portion, the ejecting mechanism pushes the heating device to move from the first position to the second position.

Preferably, the ejecting mechanism comprises a supporting base and an elastic member, the supporting base is at least partially slidably mounted to the mounting chamber, one end of the elastic member is abutted against the supporting base, and the other end is abutted against the main body; when the heating device moves from the second position to the first position, the supporting base is pushed to extrude the elastic member so that the locking device engages with the locking portion; and when the locking device is disengaged from the locking portion, the elastic member pushes the supporting base to move so that the heating device moves from the first position to the second position.

Preferably, the main body is further provided with a conductive terminal at an end of the mounting chamber away from the opening, the heating device is correspondingly provided with a conductive contact, the supporting base comprises a hollow guiding tube and a supporting edge provided at an end of the guiding tube, one end of the elastic member is sleeved on the outer circumference of the guiding tube and is abutted against the supporting edge, the other end is abutted against the main body, one end of the guiding tube away from the supporting edge is slidably sleeved on the outer circumference of the conductive terminal, and when the heating device is mounted to the first position by the opening of the mounting chamber, the heating device extrudes the supporting edge to slide in the direction of the elastic member to establish an electrical connection between the conductive terminal and the conductive contact.

Preferably, the heating device comprises a heating base and a tobacco pot detachably mounted to the heating base, the tobacco pot is provided with a receiving space configured to receive the tobacco products, one of the tobacco pot and the heating base is provided with the locking portion, the heating base is electrically connected to the main body when being mounted in the first position in the mounting chamber, and the heating base heats the tobacco products received in the receiving space when being driven by electric energy.

Preferably, the heating base comprises a base body and a heat generating component, one end of the tobacco pot is detachably mounted to the base body, the heat generating component is received in the inner chamber and is partially received in the receiving space through the base body.

Preferably, the outer wall of the tobacco pot is further provided with a heat insulating layer.

The heating device of the technical solution of the present invention is provided with a mounting chamber and a locking device in the main body, the user mounts the heating device in the mounting chamber along the opening during mounting, when being mounted to the first position of the mounting chamber, the locking device cooperates with the locking portion provided by the heating device to lock the heating device to electrically connect the heating device to the main body; when the detachment is required, the user controls the locking device so that the locking device is detached from the locking portion, the heating device moves from the first position to the second position so that the heating device partially protrudes from the opening to the outside, and the user can directly pull out the heating device, effectively facilitating the user to detach the heating device from the main body of the electronic cigarette. At the same time, the detached heating device is exposed to the outside to facilitate the user to clean.

### BRIEF DESCRIPTION OF THE DRAWINGS

For a better illustration of the embodiments of the present invention or the technical solution in the prior art, accompanying drawings needed in the description of the embodiments or the prior art are simply illustrated below. Obviously, the accompanying drawings described below are some embodiments of the present invention. For those skilled in the art, other accompanying drawings may be obtained according to the structure shown in these accompanying drawings without creative work.

FIG. 1 is a cross-sectional schematic diagram when a heating device of an electronic cigarette is located in the first position of the mounting chamber according to the present invention.

FIG. 2 is a cross-sectional schematic diagram when a heating device of an electronic cigarette is located in the second position of the mounting chamber according to the present invention.

FIG. 3 is an exploded schematic diagram illustrating a heating device of an electronic cigarette mounted along the opening of the mounting chamber according to the present invention.

FIG. 4 is a perspective schematic diagram illustrating a connecting structure of a locking device of an electronic cigarette mounted in the heating device according to the present invention.

FIG. 5 is a cross-sectional schematic diagram illustrating a connecting structure of a locking device of an electronic cigarette mounted in the heating device according to the present invention.

FIG. 6 is an exploded schematic diagram illustrating a connecting structure of a locking device of an electronic cigarette mounted in the heating device according to the present invention.

### DESCRIPTION OF THE REFERENCE NUMBERS

| Reference | | Reference | |
|---|---|---|---|
| number | Name of part | number | Name of part |
| 100 | electronic cigarette | 34 | conductive contact |
| 10 | Main body | 341 | positive electrode contact |
| 11 | mounting chamber | 342 | negative electrode contact |
| 111 | opening | 50 | locking device |
| 12 | conductive terminal | 51 | locking head |
| 30 | heating device | 511 | limiting portion |
| 31 | heating base | 512 | connecting portion |
| 311 | base body | 513 | positioning post |
| 3111 | inner chamber | 52 | controlling member |
| 312 | heat generating | 53 | elastic body |
| | component | | |
| 3121 | heat generating rod | 70 | ejecting mechanism |
| 3122 | circuit board | 71 | supporting base |
| 32 | tobacco pot | 711 | guiding tube |
| 321 | locking portion | 712 | supporting edge |
| 322 | connecting thread | 72 | elastic member |
| 33 | receiving space | | |

The implementation of aims, the function features and the advantages of the present disclosure are described below in further detail in conjunction with embodiments with reference to the drawings.

### DESCRIPTION OF THE EMBODIMENTS

A clear and complete description as below is provided for the technical solution in the embodiments of the present invention in conjunction with the drawings in the embodiments of the present invention. Obviously, the embodiments described hereafter are simply part embodiments of the present invention, rather than all the embodiments. All other embodiments obtained by those skilled in the art based on the embodiments in the present invention without creative work are intended to be included in the scope of protection of the present invention.

It should be noted that all directional indications (such as top, bottom, left, right, front, behind . . . ) in the embodiments of the present invention are merely to illustrate a relative position relation, a relative motion condition, etc. between each part in a certain state (for example, the state shown in the drawings). If the state changes, the directional indication changes accordingly.

In addition, if terms “first”, “second”, etc. appear in the present invention, they are merely for the purpose of description, but cannot be understood as the indication or implication of relative importance or as the implicit indication of the number of the designated technical features; therefore, features defined by “first” and “second” may specifically or implicitly comprise at least one such feature. In addition, technical solutions of each embodiment of the present invention may be combined mutually; however, this must be carried out on the basis that those skilled in the art can implement the combination. When the combination of technical solutions has a conflict or cannot be implemented, it should considered that such combination of technical solutions does not exist and is not in the scope of protection claimed by the present invention.

In the present invention, unless otherwise specifically stated and defined, terms “connected”, “fixed”, etc. should be interpreted expansively. For example, “fixed” may be fixed connection, detachable connection, or integration; may be mechanical connection or electrical connection; direct connection, indirect connection through an intermediate, or internal communication between two elements or interaction of two elements, unless otherwise specifically defined. Those skilled in the art can understand the specific implication of the above terms in the present invention according to specific conditions.

The present invention provides a low temperature electronic cigarette 100 adopting “heating non-burning”. Only heating but not burning tobacco at a lower temperature below 500° C. enables nicotine and some tobacco flavor components to be transferred to smoke, significantly reducing the release of tar and harmful components.

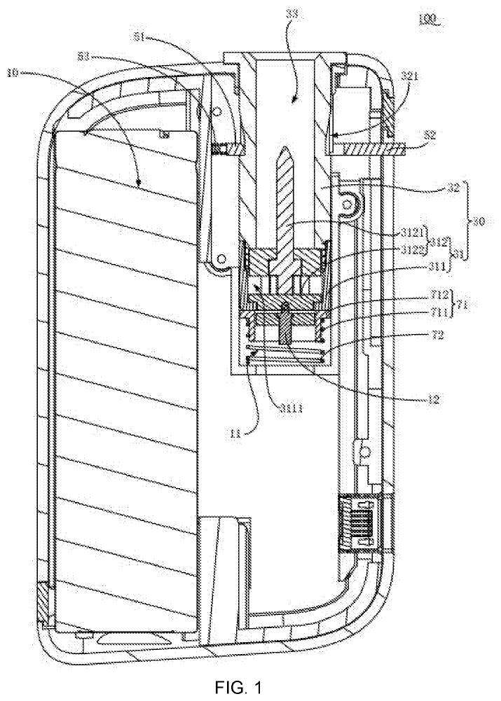

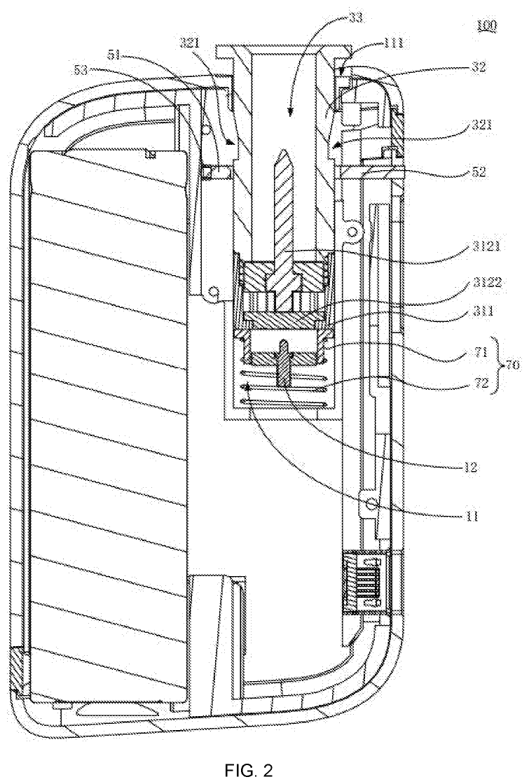

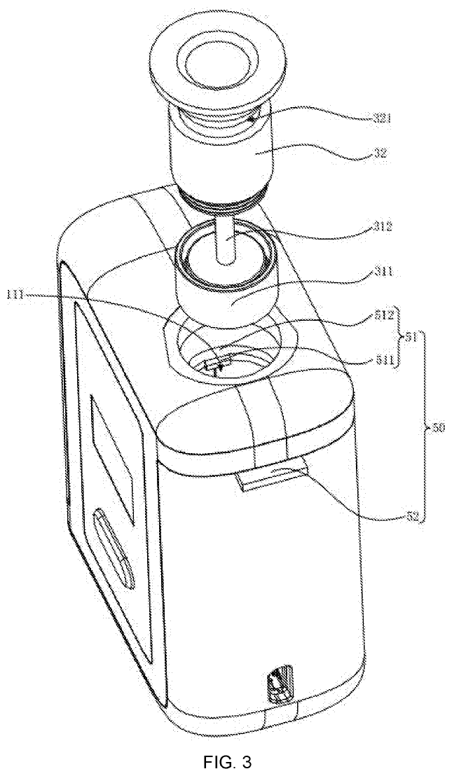

Referring to FIG. 1, FIG. 2 and FIG. 3, in the embodiment of the present invention, the electronic cigarette 100 comprises a main body 10, a heating device 30, and a locking device 50 movably mounted to the main body 10, wherein the main body 10 is provided with a mounting chamber 11 having an opening 111, the heating device 30 is detachably mounted in the mounting chamber 11, the heating device 30 is provided with a locking portion 321, when the locking device 50 moves to engage with the locking portion 321, the heating device 30 is locked in the first position in the mounting chamber to electrically connect the heating device 30 with the main body 10, the locking device 50 moves to be disengaged from the locking portion 321, and the heating device 30 moves from the first position to the second position, so that the heating device 30 partially protrudes from the opening 111 of the mounting chamber 11.

The heating device 30 of the technical solution of the present invention is provided with a mounting chamber 11 and a locking device 50 in the main body 10, the user mounts the heating device 30 in the mounting chamber 11 along the opening 111 during mounting, when being mounted to the first position of the mounting chamber 11, the locking device 50 cooperates with the locking portion 321 provided by the heating device 30 to lock the heating device 30 to electrically connect the heating device 30 to the main body 10; when the detachment is required, the user controls the locking device 50 so that the locking device 50 is detached from the locking portion 321, the heating device 50 moves from the first position to the second position so that the heating device 50 partially protrudes from the opening 111 to the outside, and the user can directly pull out the heating device 30, effectively facilitating the user to detach the heating device 30 from the main body 10 of the electronic cigarette 100. At the same time, the detached heating device 30 is exposed to the outside to facilitate the user to clean.

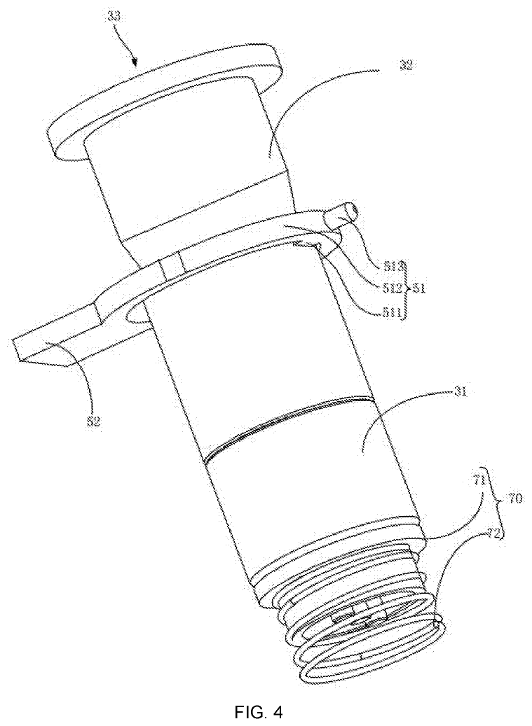

Specifically, as shown in FIG. 1, FIG. 2 or FIG. 4, in the embodiment of the present invention, the locking device 50 comprises a locking head 51 and a controlling member 52, one end of the controlling member 52 is movably mounted to the main body 10 and exposed to the outside of the main body 10, and the other end extends into the main body 10 to be connected with the locking head 51; the controlling member 52 moves to the locking head 51 to engage with the locking portion 321, a locking state is formed so that the heating device 30 is locked in the first position, and when the controlling member 52 moves to disengage the locking head 51 from the locking portion 321, a disengaged state is formed. The heating device 30 moves from the first position to the second position. Here, in the present embodiment, one end of the controlling member 52 is exposed to the outside of the main body 10, and the other end extends into the main body 10 to be connected with the locking head 51; when the user drives the controlling member 52 to move, the locking head 51 is driven to move, effectively facilitating the user to control.

Specifically, the main body 10 is provided with a connecting hole, one end of the controlling member 52 is exposed outside the connecting hole, and the other end is received in the main body 10 to be connected with the locking head 51 through the connecting hole. The user presses the controlling member 52 so that the controlling member 52 moves toward the main body 10 along the connecting hole, thereby driving the locking head 51 to engage with the mounting portion so as to lock the heating device 30 in the first position of the mounting chamber 11.

It can be understood that, in the actual application process, the controlling member 52 and the main body 10 are not limited to the above splicing manner using the connecting hole; for example, in another embodiment of the present invention, the main body 10 can also be provided with a sliding slot. One end of the controlling member 52 is slidably mounted to the sliding slot, and the other end is received in the main body 10 through the sliding slot and is connected to the locking head 51. The manner, in which the controlling member 52 slides to drive the locking head 51, is also within the scope of protection of the present invention.

Further, as shown in FIG. 1 or FIG. 2, in the embodiment of the present invention, the locking device 50 further comprises an elastic body 53, and the elastic body 53 is mounted between the main body 10 and the controlling member 52 so that the controlling member 52 rebounds from the disengaged position to the locked position. Here, the elastic body 53 can be prepared using a material such as a spring, an elastic silicone or an elastic plastic. In the present embodiment, the elastic body 53 is a spring, one end of the spring is elastically abutted with the main body 10, and the other end is elastically abutted with the controlling member 52, so that the controlling member 52 can be rebounded from the position of the disengaged state to the position of the locked state, further facilitating the user to control and detach the heating device 30 from the mounting chamber 11.

It can be understood that, in the actual application process, the elastic body 53 is not limited to the above mounting manner of being provided between the main body 10 and the controlling member 52. For example, in another embodiment of the present invention, the mounting manner, in which the elastic body 53 may also be provided between the main body 10 and the locking head 51, and when the external force of the controlling member 52 disappears, the elastic body 53 pushes the locking head 51 to drive the controlling member 52 to move from the position of the disengaged state to the position of the locked state, is within the scope of protection of the present invention.

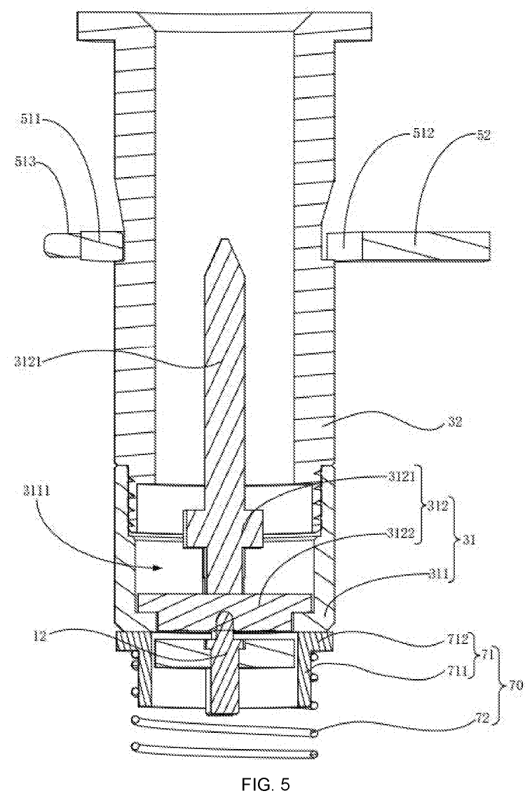

Specifically, as shown in FIG. 4 or FIG. 5, in the embodiment of the present invention, the locking head 51 comprises a limiting portion 511 and a connecting portion 512 connected to the limiting portion 511, the heating device 30 is provided with a locking groove to form the locking portion 321, one end of the connecting portion 512 away from the limiting portion 511 is mounted to the controlling member 52, and when the controlling member 52 moves to splice the limiting portion 511 into the locking groove, the heating device 30 is locked in the first position. Here, in the present embodiment, the heating device 30 is shaped like a cylindrical-shape of a cylinder. The locking groove is an annular locking groove extending in a circumferential direction of the heating device 30 so that when the heating device 30 is mounted to the mounting chamber 11 along the opening 111, the limiting portion 511 is always insertable into the locking groove, effectively preventing the phenomenon that the locking groove is provided in the single direction of the heating device 30, and it is necessary to mount in a certain direction during mounting, which causes inconvenience in mounting. The connecting portion 512 is provided with a through hole through which the heating device 30 passes, which has an annular shape in whole. The limiting portion 511 is convexly formed from the inner hole wall of the through hole, and the limiting portion 511 is provided away from the controlling member 52. The elastic body 53 is provided on a side of the connecting portion 512 away from the limiting portion 511. When the heating device 30 is mounted in the first position, the elastic body 53 presses the limiting portion 511 against the locking groove under the elastic force, effectively preventing the phenomenon that the heating device 30 waggles in the circumferential direction of the mounting chamber 11 during use. At the same time, the connecting portion 512 has an annular shape, which effectively disperses the locking force, and prevents the phenomenon that it is easy to deform when the single connecting plate or the connecting rod is subjected to a large force. The controlling member 52 is spliced into the main body 10 and is slidable along the main body 10. When the user presses the controlling member 52, the limiting portion 511 is driven to be disengaged from the locking groove and extrude the elastic body 53 at the same time so that the heating device 30 is detachable from the mounting chamber 11. When the external force applied by the user to the controlling member 52 is eliminated, the elastic body 53 is restored to deform, and the controlling member 52 is pushed back to the unpressed state, effectively facilitating the user to control.

It can be understood that, in the actual application process, the connecting portion 512 is not limited to the above annular form. For example, the manner, in which it is also possible to provide a shape such as a rod shape, a bent shape, a lever device or the like according to the internal space of the main body 10, is within the scope of protection of the present invention.

Similarly, the locking portion 321 is not limited to forming the locking portion 321 in such a manner that the heating device 30 is provided with a locking groove. For example, in another embodiment of the present invention, the heating device 30 may be provided with a locking hole to form a locking portion 321, the limiting portion 511 is a connecting pin, the locking hole is inserted by being driven by the controlling member 52, and the heating device 30 is locked; for another example, the heating device 30 is convexly provided with a wedge-shaped limiting block to form a locking portion 321, the limiting portion 511 is fitted to the wedge-shaped face of the limiting block, and the elastic body 53 is provided between the main body 10 and the controlling member 52. When the heating device 30 is mounted to the mounting chamber 11, the limiting block extrudes the limiting portion 511 to drive the controlling member 52 to move outwardly of the main body 10, and extrudes the elastic member 72. When the heating device 30 moves to a deeper position of the mounting chamber 11, when the limiting block is disengaged from the limiting portion 511, the limiting portion 511 moves into the mounting chamber 11 under the elastic restoring force of the elastic body 53, and is abutted against the side of the limiting block toward the opening 111 so that the heating device 30 is locked in the main body 10. The above manners are within the scope of protection of the present invention.

Specifically, as shown in FIG. 4, in the embodiment of the present invention, the connecting portion is further provided with a positioning post 513 corresponding to the elastic body 53, and the main body 10 is provided in the positioning groove corresponding to the elastic body 53, effectively preventing the phenomenon that the elastic body 53 is detached during use. At the same time, the positioning post 513 and the limiting portion 511 are provided on opposite side walls of the connecting member, so that the connecting member provided at the limiting portion 511 has a large thick size, and the stability of the limiting portion 511 is effectively enhanced.

Specifically, as shown in FIG. 1 and FIG. 2, in the embodiment of the present invention, the locking device 50 further comprises an ejecting mechanism 70, the ejecting mechanism 70 is mounted to the main body 10, when the heating device 30 is locked in the first position, the ejecting mechanism 70 is extruded, and when the locking device 50 is disengaged from the locking portion 321, the ejecting mechanism 70 pushes the heating device 30 to move from the first position to the second position. Here, in the present embodiment, an ejecting mechanism 70 is provided, the ejecting mechanism 70 is mounted to an end of the mounting chamber 11 away from the opening 111, so that when the user drives the controlling member 52 to disengage the locking head 51 from the locking portion 321, the ejecting mechanism 70 ejects the heating device 30 from the first position to the second position to expose the heating device from the opening 111, further facilitating the user to detach. At the same time, an ejecting mechanism 70 is provided. When the heating device 30 is locked in the first position, the ejecting mechanism 70 has an elastic force on the heating device 30, so that the heating device 30 is abutted against the locking head 51, effectively preventing the phenomenon that the heating device 30 waggles in the axial direction of the mounting chamber 11 during use.

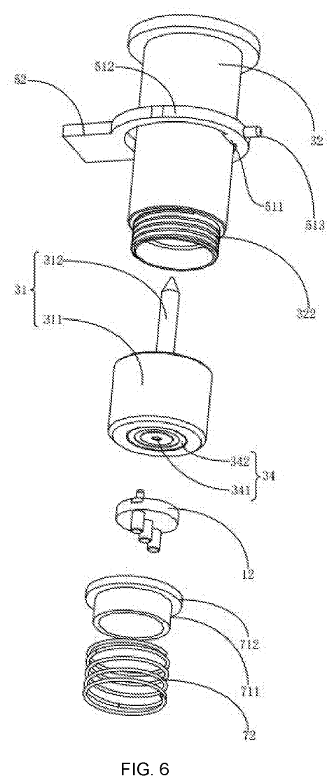

Specifically, as shown in FIG. 6, in the embodiment of the present invention, the ejecting mechanism 70 comprises a supporting base 71 and an elastic member 72, the supporting base 71 is slidably mounted to the main body 10 and at least partially received in the mounting chamber 11, one end of the elastic member 72 is abutted against the supporting base 71, and the other end is abutted against the main body 10; the heating device 30 is abutted against the supporting base 71 when moving to the second position along the opening 111, when the heating device 30 moves from the second position to the first position of the mounting chamber 11, the supporting base 71 is pushed to extrude the elastic member 72 so that the locking device 50 engages with the locking portion 321; and when the locking device 50 is disengaged from the locking portion 321, the elastic member 72 pushes the supporting base 71 to move so that the heating device 30 moves from the first position to the second position. Here, the elastic member 72 may be a spring, an elastic silicone, an elastic plastic or the like. In the present embodiment, the elastic member 72 is a spring, the supporting base 71 is slidably mounted in the mounting chamber 11, and the outer peripheral surface of the supporting base 71 is fitted to the inner peripheral surface of the mounting chamber 11. One end of the elastic member 72 is elastically abutted against the chamber wall of the mounting chamber 11 away from the opening 111, and the other end is elastically abutted against the supporting base 71. The heating device 30 is elastically abutted against an end of the supporting base 71 away from the elastic member 72 when being mounted to the heating base 31 along the opening 111, so that the supporting base 71 can push the heating device 30 to move to the second position along the mounting chamber 11 under the elastic restoring force of the elastic member 72. At the same time, a supporting base 71 is provided to cover the elastic member 72, so that the aesthetic appearance performance is high. At the same time, the outer peripheral surface of the supporting base 71 is fitted to the inner peripheral surface of the mounting chamber 11, effectively preventing the phenomenon that the supporting base 71 waggles during the movement.

It can be understood that, in the actual application process, the supporting base 71 is not limited to the above mounting manner in which the outer peripheral surface is fitted to the inner peripheral surface of the mounting chamber 11 to prevent waggle; for example, the mounting manner, in which a guiding groove is also provided in the inner chamber wall of the mounting chamber 11, the outer surface of the supporting base 71 is provided with a guiding member, and the guiding member is spliced in the guiding groove to cooperatively slide to prevent waggle, is within the scope of protection of the present invention.

In addition, in the actual application process, the supporting base 71 is not limited to the above mounting manner of being received in the mounting chamber 11. For example, in another embodiment of the present invention, the manner, in which the supporting base 71 is slidably mounted in the main body 10, the inner chamber wall of the mounting chamber 11 is provided with a sliding slot, and the supporting base 71 partially extends into the mounting chamber 11 through the sliding slot and is elastically abutted against the heating device 30, is also within the scope of protection of the present invention.

Specifically, as shown in FIG. 5, in the embodiment of the present invention, the main body 10 is further provided with a conductive terminal 12 at an end of the mounting chamber 11 away from the opening 111, the heating device 30 is correspondingly provided with a conductive contact 34, the supporting base 71 comprises a hollow guiding tube 711 and a supporting edge 712 provided at an end of the guiding tube 711, one end of the elastic member 72 is sleeved on the outer circumference of the guiding tube 711 and is abutted against the supporting edge 712, the other end is abutted against the main body 10, one end of the guiding tube 711 away from the supporting edge 712 is slidably sleeved on the outer circumference of the conductive terminal 12, and when the heating device 30 is mounted to the first position by the opening 111 of the mounting chamber 11, the heating device 30 extrudes the supporting edge 712 to slide in the direction of the elastic member 72 to establish an electrical connection between the conductive terminal 12 and the conductive contact 34. Here, in the present embodiment, the heating device 30 is a cylindrical cylinder, the conductive contact 34 comprises a positive electrode contact 341 and a negative electrode contact 342, the negative electrode contact 342 is provided at a bottom end of the heating device 30 and is provided in an annular shape, and the positive electrode contact 341 is provided in the annular middle portion surrounded by the negative electrode contact 342. The conductive terminal 12 comprises a positive conductive ejector pin and two negative conductive ejector pins, and the positive conductive elastic body is provided corresponding to the positive electrode contact 341; and the two negative conductive ejector pins are provided symmetrically with respect to the positive conductive ejector pin and is provided corresponding to the annular track surrounded by the negative electrode contact 342. When the heating device 30 is mounted to the mounting chamber 11 along the opening 111 at an arbitrary position, the negative electrode contact 342 and the positive electrode contact 341 are always corresponding to the positive conductive ejector pin and the negative conductive ejector pins, thereby effectively preventing the phenomenon that electrode contact misalignment results in circuit failure. At the same time, the conductive terminal 12 uses a conductive ejector pin to form an elastic contact between the conductive terminal 12 and the conductive contact 34, so that the conductive contact 34 provided in the heating device 30 is effectively closely abutted against the ejector pin provided in the mounting chamber 11 and the stability of current conduction is enhanced. Moreover, the guiding tube is slidably sleeved on the outer circumference of the conductive terminal, thereby effectively achieving positioning and preventing the phenomenon of waggling during the sliding process.

In addition, the conductive terminal 12 is provided at the bottom of the mounting chamber 11. When the locking head 51 is disengaged from the locking portion 321, the three conductive ejector pins have an ejection force for the heating device 30, helping the elastic member 72 to eject the heating device 30 from the first position to the second position.

Specifically, as shown in FIG. 6, in the embodiment of the present invention, the heating device 30 comprises a heating base 31 and a tobacco pot 32 detachably mounted to the heating base 31, the tobacco pot 32 is provided with a receiving space 33 configured to receive the tobacco products, one of the tobacco pot 32 and the heating base 31 is provided with the locking portion 321, the heating base 31 is electrically connected to the main body 10 when being mounted in the first position in the mounting chamber 11, and the heating base 31 heats the tobacco products received in the receiving space 33 when being driven by electric energy. Here, in the present embodiment, the tobacco pot 32 is a hollow sleeve. One end of the sleeve is provided with a connecting thread 322. The heating base 31 is provided with an internal thread, and the heating base and the internal thread are detachably connected by thread engagement. When cleaning, the sleeve can be detached from the heating base 31, and then immersed and cleaned by clear water or cleaning liquid. The outer surface of the heating base 31 is also cleaned by wiping, thereby effectively preventing the phenomenon that the heating base 31 and the sleeve cannot be detached and it is easy for water to enter the heating base 31 to cause a short circuit when being cleaned.

It can be understood that, in the actual application process, the sleeve and the heating base 31 are not limited to the above detachable manner using a threaded connection. For example, the detachable connection manners such as snaps or latches are also within the scope of protection of the present invention.

Specifically, as shown in FIG. 6, in the embodiment of the present invention, the heating base 31 comprises a base body 311 and a heat generating component 312, one end of the tobacco pot 32 is detachably mounted to the base body 311, the heat generating component 312 is received in the inner chamber 3111 and is partially received in the receiving space 33 through the base body 311. Here, in the present embodiment, the heat generating component 312 comprises a heat generating rod 3121 and a circuit board 3122. The circuit board 3122 is mounted to the inner chamber 3111, one end of the heat generating rod 3121 is received in the inner chamber 3111 and is electrically connected to the circuit board 3122, and the other end is received outside through the base body 311. When the tobacco pot 32 is mounted to the base body 311, the heat generating rod 3121 is received in the receiving space 33 to directly heat tobacco products, thereby effectively improving the heating efficiency and reducing the energy consumption. The conductive contact 34 is provided at an end of the circuit board 3122 away from the heat generating rod 3121, and the base body 311 is provided at the retaining port corresponding to the conductive contact 34 so that when the base body 311 is mounted in the first position of the mounting chamber 11, the conductive contact 34 is electrically connected to the conductive terminal 12.

It can be understood that, in the actual application process, the heat generating component 312 is not limited to the above manner of directly heating the tobacco products received inside the receiving space 322 through the base body 311 using the heat generating rod 3121. For example, in another embodiment of the present invention, the manner, in which the heat generating component 312 can also heat the tobacco pot 32 by winding the heating wire around the outer wall of the tobacco pot 32, is also within the scope of protection of the present invention.

Specifically, the outer wall of the tobacco pot 32 is further provided with a heat insulating layer (not labeled). Here, in the present embodiment, the outer wall of the tobacco pot 32 is further provided with a heat insulating layer, which effectively prevents the phenomenon that the heat inside the receiving space 33 is dissipated into the inside of the main body 10, thereby causing damage to the electronic components received inside. At the same time, the heat inside the receiving space 33 is concentrated to improve the baking efficiency.

It can be understood that, in the actual application process, the heat insulating layer is not limited to the above manner of realizing heat insulation by being provided on the outer wall of the tobacco pot 32. For example, the manner, in which the heat insulating layer may be provided on the inner wall of the receiving space 33, or the tobacco pot 32 is prepared using an insulating material, is within the scope of protection of the present invention.

The above are preferred embodiments of the present invention merely and are not intended to limit the patent scope of the present invention. Any equivalent structures made according to the description and the accompanying drawings of the present invention without departing from the idea of the present invention, or any equivalent structures applied in other relevant technical fields directly or indirectly are intended to be included in the patent scope of protection of the present invention.

What is claimed is:

1. An electronic cigarette, comprising:
a main body,
a heating device, and
a locking device movably mounted to the main body,
wherein the main body is provided with a mounting chamber having an opening, the heating device is detachably mounted in the mounting chamber, the heating device is provided with a locking portion, when the locking device moves to engage with the locking portion, the heating device is locked in the first position in the mounting chamber to electrically connect the heating device with the main body, when the locking device moves to be disengaged from the locking portion, and the heating device moves from the first position to the second position, so that the heating device partially protrudes from the opening of the mounting chamber.

2. The electronic cigarette according to claim 1, wherein the locking device comprises a locking head and a controlling member, one end of the controlling member is movably mounted to the main body and exposed to the outside of the main body, and the other end extends into the main body to be connected with the locking head; the controlling member moves to the locking head to engage with the locking portion, the heating device is locked in the first position, the controlling member moves to disengage the locking head from the locking portion, and the heating device moves from the first position to the second position.

3. The electronic cigarette according to claim 2, wherein the locking device further comprises an elastic body, and the elastic body is mounted between the main body and the controlling member, so that the controlling member rebounds.

4. The electronic cigarette according to claim 2, wherein the locking head comprises a limiting portion and a connecting portion connected to the limiting portion, the heating device is provided with a locking groove to form the locking portion, one end of the connecting portion away from the limiting portion is mounted to the controlling member, and when the controlling member moves a position where the limiting portion is engaged in the locking groove, the heating device is locked in the first position.

5. The electronic cigarette according to claim 1, wherein the locking device further comprises an ejecting mechanism, the ejecting mechanism is mounted to the main body, when the heating device is locked in the first position, the ejecting mechanism is extruded, and when the locking device (50) is disengaged from the locking portion, the ejecting mechanism is configured for pushing the heating device to move from the first position to the second position.

6. The electronic cigarette according to claim 5, wherein the ejecting mechanism comprises a supporting base and an elastic member, the supporting base is at least partially slidably mounted to the mounting chamber, one end of the elastic member is abutted against the supporting base, and the other end is abutted against the main body; when the heating device moves from the second position to the first position, the supporting base is pushed to extrude the elastic member, so that the locking device is engaged with the locking portion; and when the locking device is disengaged from the locking portion, the elastic member is configured for pushing the supporting base to move, so that the heating device moves from the first position to the second position.

7. The electronic cigarette according to claim 6, wherein the main body is further provided with a conductive terminal at an end of the mounting chamber away from the opening, the heating device is correspondingly provided with a conductive contact, the supporting base comprises a hollow guiding tube and a supporting edge provided at an end of the guiding tube, one end of the elastic member is sleeved on the outer circumference of the guiding tube and is abutted against the supporting edge, the other end is abutted against the main body, one end of the guiding tube away from the supporting edge is slidably sleeved on the outer circumference of the conductive terminal, and when the heating device is mounted to the first position by the opening of the mounting chamber, the heating device extrudes the supporting edge to slide in the direction of the elastic member to establish an electrical connection between the conductive terminal and the conductive contact.

8. The electronic cigarette according to claim 1, wherein the heating device comprises a heating base and a tobacco pot detachably mounted to the heating base, the tobacco pot is provided with a receiving space configured for receiving the tobacco products, one of the tobacco pot and the heating base is provided with the locking portion, the heating base is electrically connected to the main body when being mounted in the first position in the mounting chamber, and the heating base heats the tobacco products received in the receiving space (33) when being driven by electric energy.

9. The electronic cigarette according to claim 8, wherein the heating base comprises a base body and a heat generating component, one end of the tobacco pot is detachably mounted to the base body, the heat generating component is received in the inner chamber and is partially received in the receiving space through the base body.

10. The electronic cigarette according to claim 8, wherein the outer wall of the tobacco pot is further provided with a heat insulating layer.

11. The electronic cigarette according to claim 2, wherein the locking device further comprises an ejecting mechanism, the ejecting mechanism is mounted to the main body, when the heating device is locked in the first position, the ejecting mechanism is extruded, and when the locking device is disengaged from the locking portion, the ejecting mechanism is configured for pushing the heating device to move from the first position to the second position.

12. The electronic cigarette according to claim 3, wherein the locking device further comprises an ejecting mechanism, the ejecting mechanism is mounted to the main body, when the heating device is locked in the first position, the ejecting mechanism is extruded, and when the locking device is disengaged from the locking portion, the ejecting mechanism is configured for pushing the heating device to move from the first position to the second position.

13. The electronic cigarette according to claim 4, wherein the locking device further comprises an ejecting mechanism, the ejecting mechanism is mounted to the main body, when the heating device is locked in the first position, the ejecting mechanism is extruded, and when the locking device is disengaged from the locking portion, the ejecting mechanism is configured for pushing the heating device to move from the first position to the second position.

14. The electronic cigarette according to claim 2, wherein the heating device comprises a heating base and a tobacco pot detachably mounted to the heating base, the tobacco pot is provided with a receiving space configured for receiving the tobacco products, one of the tobacco pot and the heating base is provided with the locking portion, the heating base is electrically connected to the main body when being mounted in the first position in the mounting chamber, and the heating base heats the tobacco products received in the receiving space when being driven by electric energy.

15. The electronic cigarette according to claim 3, wherein the heating device comprises a heating base and a tobacco pot detachably mounted to the heating base, the tobacco pot is provided with a receiving space configured for receiving the tobacco products, one of the tobacco pot and the heating base is provided with the locking portion, the heating base is electrically connected to the main body when being mounted in the first position in the mounting chamber, and the heating base heats the tobacco products received in the receiving space when being driven by electric energy.

16. The electronic cigarette according to claim 4, wherein the heating device comprises a heating base and a tobacco pot detachably mounted to the heating base, the tobacco pot is provided with a receiving space configured for receiving the tobacco products, one of the tobacco pot and the heating base is provided with the locking portion, the heating base is electrically connected to the main body when being mounted in the first position in the mounting chamber, and the heating base heats the tobacco products received in the receiving space (33) when being driven by electric energy.
